(19) United States
(12) Patent Application Publication
(10) Pub. No.: US 2016/0367340 A1
(43) Pub. Date: Dec. 22, 2016

(54) ORTHODONTIC BRACKET AND METHOD OF CORRECTING MALPOSITIONED TEETH

(71) Applicant: Ormco Corporation, Orange, CA (US)

(72) Inventor: Steve Ward, Calgary (CA)

(73) Assignees: Ormco Corporation, Orange, CA (US); Ormco Corporation, Orange, CA (US)

(21) Appl. No.: 15/185,935

(22) Filed: Jun. 17, 2016

Related U.S. Application Data
(60) Provisional application No. 62/181,953, filed on Jun. 19, 2015.

(51) Int. Cl. A61C 7/28

(52) U.S. Cl. CPC A61C 7/287

(57) ABSTRACT

An orthodontic bracket includes a bracket body including an archwire slot having a base surface, a first side wall and a second side. The bracket further includes a closure member movable between an open position and a closed position including an archwire control structure to enhance rotational control during treatment. The closure member includes a generally planar surface that confronts the archwire slot in the closed position. The archwire control structure includes a first projecting portion and a second projecting portion, and a recessed area is defined by the planar surface and first and second projecting portions which overlies the archwire slot when the closure member is in the closed position. A method of correcting malpositioned teeth is also disclosed.

### TECHNICAL FIELD

The invention relates generally to orthodontic brackets, and more particularly to orthodontic brackets having features that off-set manufacturing tolerance stack ups, and thus provide enhanced rotational control during orthodontic treatment.

### BACKGROUND

Orthodontic brackets represent a principal component of all corrective orthodontic treatments devoted to improving a patient's occlusion. In conventional orthodontic treatments, an orthodontist or an assistant affixes brackets to the patient's teeth and engages an archwire into a slot of each bracket. The archwire applies corrective forces that coerce the teeth to move into correct positions. Traditional ligatures, such as small elastomeric O-rings or fine metal wires, are employed to retain the archwire within each bracket slot. Due to difficulties encountered in applying an individual ligature to each bracket, self-ligating orthodontic brackets have been developed that eliminate the need for ligatures by relying on a movable portion or member, such as a latch or slide, for retaining the archwire within the bracket slot.

While such self-ligating brackets are generally successful in achieving their intended purpose, there remain some drawbacks. By way of example, in some instances controlling the rotation of the teeth, such as near the finishing stages of orthodontic treatment, can be problematic. While there may be several factors that cause a reduction in rotational control, it is believed that one of the major causes is the loose fit of the archwire within the archwire slot of the bracket when the movable member is closed. When the movable member is closed, the bracket body and the movable member collectively form a closed lumen for capturing the archwire. A close fit between the lumen and the archwire is believed to be important for achieving excellent rotational control during orthodontic treatment.

The close fit between the archwire and the archwire slot when the movable member is closed may be affected by several factors including, for example, the tolerances of the manufacturing process used to form the bracket body and the movable member. When the orthodontic bracket is assembled, the various tolerances may “stack up” so as to provide a relatively loose fit between the archwire and the closed lumen provided by the bracket body and movable member. As noted above, such a loose fit is believed to result in a diminished capacity to control the rotation of the teeth. There may be several sources of tolerance stack ups, including variation in the depth of the archwire slot formed in the bracket body, variation in the thickness of the movable member, variation in the track or window in the bracket body which receives the movable member, and variations in the dimensions of the archwire. The tolerances stack up to provide a lumen/wire geometry which may significantly vary in its labial-lingual dimension and therefore provide a relatively loose fit with the archwire.

Thus, while self-ligating brackets have been generally successful, manufacturers of such brackets continually strive to improve their use and functionality. In this regard, there remains a need for self-ligating orthodontic brackets that provide the ability to off-set manufacturing tolerance stack ups, and thus provide improved rotational control during orthodontic treatment.

### SUMMARY

An orthodontic bracket includes a bracket body adapted to be secured to a tooth and including an archwire slot having a base surface, a first side wall and a second side wall each extending from the base surface, the archwire slot further including an opening opposite the base surface for receiving an archwire therein. The bracket further includes a closure member movable between an open position and a closed position, wherein the bracket body is configured to receive the archwire in the archwire slot when in the open position and configured to retain the archwire in the archwire slot when in the closed position. The closure member includes an archwire control structure to enhance rotational control during orthodontic treatment, wherein the closure member includes a generally planar surface that confronts the archwire slot in the closed position. The archwire control structure includes a first projecting portion adjacent a first side of the closure member and projecting above the generally planar surface, and a second projecting portion adjacent a second side of the closure member and projecting above the generally planar surface. A recessed area is defined by the generally planar surface and first and second projecting portions which overlies the archwire slot when the closure member is in the closed position.

In one embodiment, the first and second projecting portions include ribs projecting above the generally planar surface of the closure member. The closure member moves between the open and closed positions along a translation axis, and each of the ribs extends in a direction substantially parallel to the translation axis. In a further aspect, the bracket body includes a support surface extending from one of the side walls of the archwire slot and positioned on one side of the archwire slot, wherein the support surface includes recesses that receive the first and second projecting projections when the closure member is in the opened position. The support surface may be a generally planar surface and the recesses include a pair of grooves extending below the generally planar surface. Each of the grooves may be open to the archwire slot. Additionally, each of the grooves may extend in a direction substantially parallel to the translation axis.

In one embodiment, the closure member includes a pair of spaced-apart ribs projecting above the generally planar surface of the closure member, wherein at least a portion of the ribs operates as the archwire control structure and a portion of the ribs extends beyond the archwire slot when the closure member is in the closed position. The closure member may move between the open and closed positions along a translation axis and each of the ribs may extend in a direction substantially parallel to the translation axis. In one embodiment, each of the ribs constitutes a continuous elongate member. In an alternative embodiment, each of the ribs includes an upper rib portion and a lower rib portion separated from each other, wherein the upper rib portions overlie the archwire slot when the closure member is in the closed position and operates as the archwire control structure. The bracket body may include a support surface extending from one of the side walls of the archwire slot and positioned on one side of the archwire slot, wherein the support surface includes recesses that receive at least a portion of the ribs when the closure member is in the opened position. The recesses may receive at least a portion of the ribs when the closure member is in the closed position. The support surface may be a generally planar surface and the recesses include a pair of grooves extending below the generally planar surface. Each of the grooves may be open to the archwire slot and may extend in a direction substantially parallel to the translation axis.

A method of correcting malpositioned teeth includes applying a plurality of orthodontic brackets to teeth of a patient, each bracket being as described as above, and retaining an archwire in the respective archwire slots of the orthodontic brackets such that the archwire contacts at least one of the first or second projecting portions and without contacting another portion of the ligating member. The method may further include altering a height of at least one of the projecting portions above the generally planar surface to affect rotational control on a tooth.

### BRIEF DESCRIPTION OF THE DRAWINGS

The accompanying drawings, which are incorporated in and constitute a part of this specification, illustrate embodiments of the invention and, with the general description given above, together with the detailed description given below, serve to explain various aspects of the invention.

FIG. 1 is a perspective view of a self-ligating orthodontic bracket in accordance with one embodiment of the invention, the ligating slide shown in the opened position;

FIG. 2 is a perspective view of the self-ligating orthodontic bracket shown in FIG. 1 with the ligating slide shown in the closed position;

FIG. 3 is a perspective view of the self-ligating orthodontic bracket shown in FIG. 1 with the ligating slide removed from the bracket body;

FIG. 4A is a front perspective view of the ligating slide shown in FIG. 1;

FIG. 4B is a rear perspective view of the ligating slide shown in FIG. 1;

FIG. 5 is a cross-sectional view of the orthodontic bracket shown in FIG. 2; and

FIG. 6 is another cross-sectional view of the orthodontic bracket shown in FIG. 2.

### DETAILED DESCRIPTION

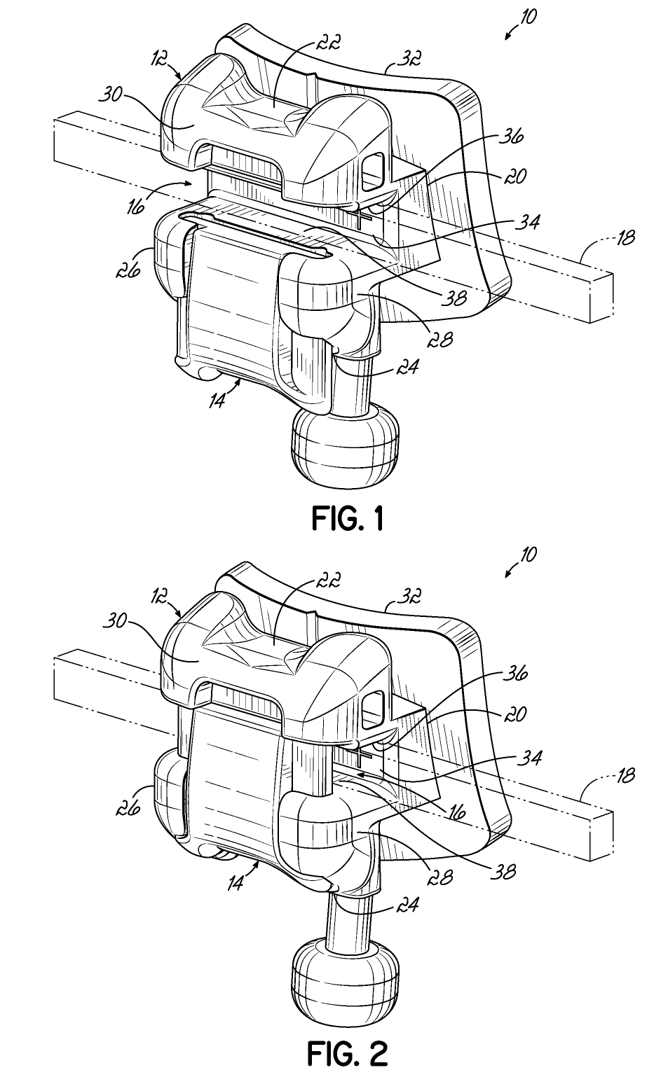

Referring now to the drawings, and to FIGS. 1 and 2 in particular, an orthodontic bracket 10 includes a bracket body 12 and a movable closure member coupled to the bracket body 12. In one embodiment, the movable closure member may include a ligating slide 14 slidably coupled with the bracket body 12. The bracket body 12 includes an archwire slot 16 formed therein adapted to receive an archwire 18 (shown in phantom) for applying corrective forces to the teeth. The ligating slide 14 is movable between an opened position (FIG. 1) in which the archwire 18 is insertable into the archwire slot 16 and a closed position (FIG. 2) in which the archwire 18 is retained within the archwire slot 16. The bracket body 12 and ligating slide 14 collectively form an orthodontic bracket 10 for use in corrective orthodontic treatments. Moreover, while the movable closure member is described herein as a ligating slide, the invention is not so limited as the movable closure member may include other movable structures (e.g., latch, spring clip, door, etc.) that are capable of moving between an opened and closed position.

The orthodontic bracket 10, unless otherwise indicated, is described herein using a reference frame attached to a labial surface of a tooth on the lower jaw. Consequently, as used herein, terms such as labial, lingual, mesial, distal, occlusal, and gingival used to describe bracket 10 are relative to the chosen reference frame. The embodiments of the invention, however, are not limited to the chosen reference frame and descriptive terms, as the orthodontic bracket 10 may be used on other teeth and in other orientations within the oral cavity. For example, the bracket 10 may also be coupled to the lingual surface of the tooth and be within the scope of the invention. Those of ordinary skill in the art will recognize that the descriptive terms used herein may not directly apply when there is a change in reference frame. Nevertheless, embodiments of the invention are intended to be independent of location and orientation within the oral cavity and the relative terms used to describe embodiments of the orthodontic bracket are to merely provide a clear description of the embodiments in the drawings. As such, the relative terms labial, lingual, mesial, distal, occlusal, and gingival are in no way limiting the invention to a particular location or orientation.

When mounted to the labial surface of a tooth carried on the patient's lower jaw, the bracket body 12 has a lingual side 20, an occlusal side 22, a gingival side 24, a mesial side 26, a distal side 28 and a labial side 30. The lingual side 20 of the bracket body 12 is configured to be secured to the tooth in any conventional manner, such as for example, by an appropriate orthodontic cement or adhesive or by a band around an adjacent tooth. The lingual side 20 may further be provided with a pad 32 defining a bonding base that is secured to the surface of the tooth. The bracket body 12 includes a base surface 34 and a pair of opposed slot surfaces 36, 38 projecting labially from the base surface 34 that collectively define the archwire slot 16 extending in a mesial-distal direction from mesial side 26 to distal side 28. The slot surfaces 36, 38 and base surface 34 are substantially encapsulated or embedded within the material of the bracket body 12. The archwire slot 16 of the bracket body 12 may be designed to receive the orthodontic archwire 18 in any suitable manner.

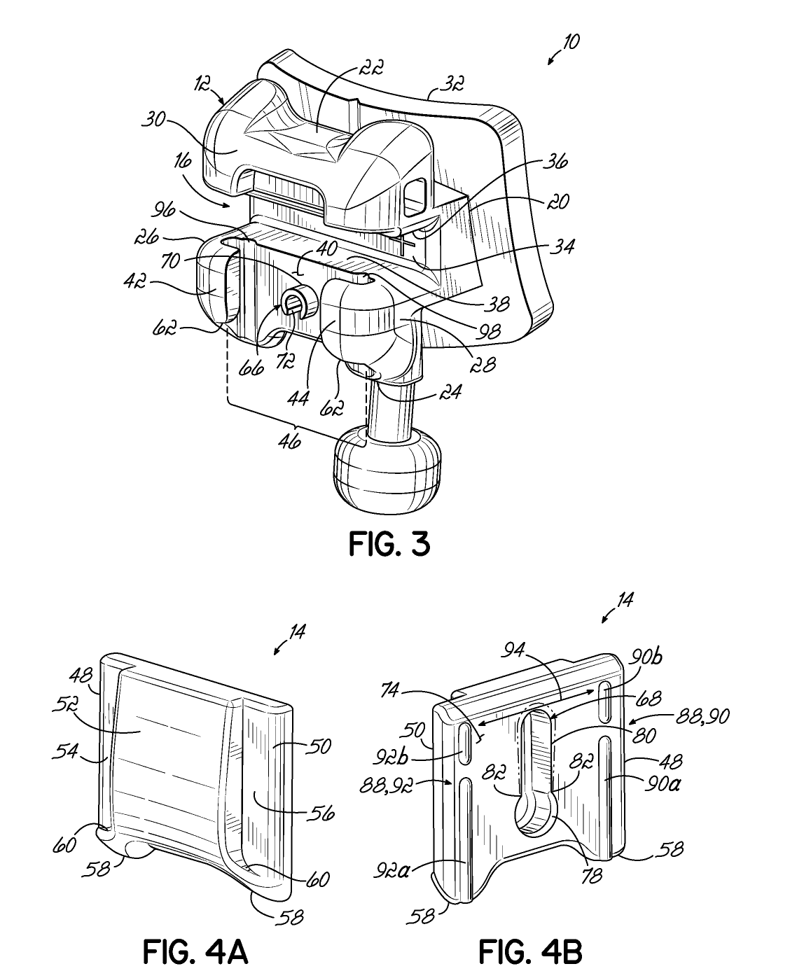

As shown in FIG. 3, the bracket body 12 further includes a generally planar support surface 40 extending in a generally gingival-occlusal direction from slot surface 38. A pair of opposed guides 42, 44 are carried by support surface 40 and are positioned on respective mesial and distal sides 26, 28 of bracket body 12. The guides 42, 44 are generally L-shaped and each includes a first leg projecting from support surface 40 generally in the labial direction. Guide 42 has a second leg projecting in the distal direction while guide 44 has a second leg projecting in the mesial direction so that collectively, guides 42, 44 partially overlie support surface 40 in a spaced relation. Planar support surface 40 and guides 42, 44 collectively define a slide engagement track 46 for supporting and guiding ligating slide 14 within bracket body 12.

As shown in FIGS. 4A and 4B, the ligating slide 14 is a generally planar structure comprising a mesial portion 48, a distal portion 50, and a central portion 52 intermediate the mesial and distal portions 48, 50. Guides 42, 44 overlie mesial and distal portions 48, 50, respectively, and central portion 52 projects in the labial direction such that the labial side of central portion 52 is substantially flush with the labial side of guides 42, 44 (FIG. 2). Such a configuration essentially defines gingival-occlusal directed tracks or grooves 54, 56 in the labial side of the ligating slide 14 along which guides 42, 44 move as the ligating slide 14 is moved between the opened and closed positions. In one embodiment, the gingival ends 58 of grooves 54, 56 may include stop portions 60 extending in the labial direction and closing off grooves 54, 56. The stop portions 60 are adapted to be adjacent or even abut a gingival end 62 of the guides 42, 44 (FIG. 3) when the ligating slide 14 is in the closed position (FIG. 2).

As shown in FIGS. 3 and 4B, the orthodontic bracket 10 includes a securing mechanism that secures the ligating slide 14 in at least the closed position. To this end, the securing mechanism includes a projecting portion in one of the bracket body 12 or ligating slide 14 and a receiving portion in the other of the bracket body 12 or ligating slide 14 that cooperate to keep the ligating slide 14 in at least the closed position, and may further prevent the ligating slide 14 from detaching from the bracket body 12. In one exemplary embodiment, the securing mechanism includes a generally elongated cylindrical, tubular spring pin 66 (FIG. 3) coupled to the bracket body 12 and a retaining slot 68 (FIG. 4B) formed in the ligating slide 14. Additional details of the spring pin 66 and retaining slot 68, as well as alternative embodiments, are disclosed in U.S. Pat. No. 8,033,824, the disclosure of which is incorporated by reference herein in its entirety.

As shown in FIG. 3, the spring pin 66 extends along a central axis and includes a first portion (not shown) received within a bore 70 formed in support surface 40 and a second portion that projects therefrom in a direction generally perpendicular to archwire slot 16, such as, for example, in a generally labial direction (e.g., the spring pin 66 projects generally in a labial-lingual direction). The spring pin 66 includes a cutout or slit 72, formed in the sidewall thereof and extends along at least a portion of the length of the spring pin 66. During assembly, the spring pin 66 may be press fit or slip fit into bore 70, and/or may be secured thereto to prevent relative movement therebetween using various processes including staking, tack welding, laser welding, adhesives, or other suitable methods.

As shown in FIG. 4B, the retaining slot 68 may be formed in the lingual side 74 of the ligating slide 14 and extends generally in the gingival-occlusal direction due to the general gingival-occlusal movement of ligating slide 14. In one embodiment, the retaining slot 68 has a first enlarged portion 78 at the gingival end of the slot 68 in communication with a straight segment portion 80 having a closed occlusal end. The enlarged portion 78 may be generally circular, as shown, or have other suitable shapes. The cross dimension of the enlarged portion 78 is larger than the cross dimension of the straight segment portion 80 to define a pair of opposed protrusions 82 at the transition therebetween.

When the ligating slide 14 is coupled to the bracket body 12, the spring pin 66 is received in retaining slot 68, which moves relative to the spring pin 66 as the ligating slide 14 is moved between the opened and closed positions. In one aspect of the invention, the spring pin/retaining slot securing mechanism provides for securing the ligating slide 14 in at least the closed position. In operation, when the ligating slide 14 is in the closed position (FIG. 2), the spring pin 66 is disposed in the enlarged portion 78 of retaining slot 68. When so disposed in the circular portion 78, the protrusions 82 provide a threshold level of resistance to any movement of the ligating slide 14 away from the closed position and toward the opened position. However, if a sufficiently large opening force is applied to the ligating slide 14 in, for example, the gingival direction, the interaction between the retaining slot 68 and spring pin 66 causes the pin 66 to radially contract so that the spring pin 66 moves past the protrusions 82 and into the straight segment portion 80 of the retaining slot 68.

Once positioned in the straight segment portion 80, the spring pin 66 bears against the walls thereof such that a threshold sliding force, which may be less than, and perhaps significantly less than the opening force, must be imposed to overcome the drag and move the ligating slide 14 relative to the bracket body 12 as spring pin 66 traverses straight segment portion 80. Thus, once opened, the ligating slide 14 does not just freely slide or drop to the fully opened position, but must be purposefully moved toward the opened position. If the ligating slide 14 is only partially opened, the slide 14 may be configured to maintain its position relative to the bracket body 12 (due to the friction forces) until the threshold sliding force is imposed to continue moving the slide 14 toward the opened position. When the ligating slide 14 is moved toward the closed position, the spring pin 66 recovers or snaps back to its radially expanded position as the spring pin 66 enters the enlarged portion 78 to once again secure the ligating slide 14 in the closed position.

In addition to sufficiently securing the ligating slide 14 in at least the closed position (and possibly in the opened and closed position), the spring pin/retaining slot securing mechanism may also prevent or reduce accidental or unintentional detachment of the ligating slide 14 from the bracket body 12 during use, such as when the ligating slide 14 is in the opened position. To this end, the length of the retaining slot 68 may limit the gingival-occlusal travel of ligating slide 14 relative to the bracket body 12. For example, the spring pin 66 may abut the occlusal end of the retaining slot 68 when the ligating slide 14 is in the fully opened position. Because the occlusal end closes the retaining slot 68, further movement of the ligating slide 14 in a gingival direction relative to bracket body 12 is prohibited, and ligating slide 14 cannot become separated or detached from bracket body 12.

Similarly, in the fully closed position of the ligating slide 14, the spring pin 66 is positioned in the enlarged portion 78 at the gingival end of the retaining slot 68, which may prohibit further movement of the ligating slide 14 in the occlusal direction relative to the bracket body 12. The orthodontic bracket 10 may include other features that, in lieu of or in addition to, the spring pin/retaining slot securing mechanism prevents movement of the ligating slide 14 in the occlusal direction relative to the bracket body 12. Accordingly, the securing mechanism may operate for the dual function of securing the ligating slide 14 in the closed position (and possibly the opened position as well) and for retaining the ligating slide 14 with the bracket body 12.

According to embodiments of the invention, the ligating slide 14 is designed with archwire control structure 88, described below, that provides predictable, consistent contact between the archwire 18 and the orthodontic bracket 10. In this regard, the archwire control structure limits contact between the archwire 18 and the ligating slide 14 to specific locations. Further, the specific locations may be predetermined and during treatment may not shift. By way of example, the archwire control structure may provide two-point contact between the orthodontic bracket 10 and the archwire 18. The archwire 18 may contact both the bracket body 12 and the ligating slide 14. In another configuration, two-point contact may occur at two locations on the ligating slide 14. In one exemplary embodiment, the archwire control structure limits contact between the archwire 18 and the ligating slide 14 to one or two predetermined locations. Additional aspects of the interaction between the archwire 18 and the ligating slide 14 are disclosed in U.S. application Ser. No. 12/689,145, the disclosure of which is incorporated by reference herein in its entirety.

In reference to FIG. 4B, and accordance with an aspect of the invention, the lingual side 74 of the ligating slide 14 includes an archwire control structure 88 comprising mesial and distal projecting portions or ribs 90, 92 spaced apart in the mesial-distal direction and extending away from (e.g., above) the generally planar surface defined by the lingual side 74 of the ligating slide 14. By way of example, one of the projecting portions 90 may be associated with the mesial portion 48 of the ligating slide 14, and the other projecting portion 92 may be associated with the distal portion 50 of the ligating slide 14 so as to define a recess or recessed area 94 therebetween. Each of the projecting portions 90, 92 extends generally in the gingival-occlusal direction, e.g., generally parallel to the central axis of the retaining slot 68. However, other configurations may be possible.

In one embodiment, the projecting portions 90, 92 may be continuous in the gingival-occlusal direction, i.e., each projecting portion 90, 92 constitutes a single elongate member. In another embodiment, and as illustrated in FIG. 4B, each projecting portion 90, 92 may include a lower portion 90a, 92a and an upper portion 90b, 92b separated from each other by a portion of the planar surface, but remain generally aligned with each other. As explained in more detail below, the lower portions 90a, 92a of the projecting portions 90, 92 are configured to engage with the support surface 40 of the bracket body 12 when the ligating slide 14 is in the closed position, and the upper portions 90b, 92b of the projecting portions 90, 92 are configured to be positioned overtop and/or within the archwire slot 16 when the ligating slide 14 is in the closed position. To accommodate the projecting portions 90, 92 on the lingual side 74 of the ligating slide 14, the bracket body 12, and more particularly the support surface 40, generally includes corresponding grooves 96, 98 formed therein and configured to receive the projecting portions 90, 92, respectively, when the ligating slide 14 is engaged with the bracket body 12 (FIG. 3). The grooves 96, 98 accommodate the projecting portions 90, 92 such that the ligating slide 14 is able to move between the opened and closed positions without interference from the bracket body 12.

As noted above, when the ligating slide 14 is in the closed position, the upper portions 90b, 92b of the projecting portions 90, 92 are positioned overtop and/or within the archwire slot 16, and therefore is configured to confront the archwire 18 when in the closed position. Due to the tolerance stack ups, the upper portions 90b, 92b of the rails 90, 92 may or may not engage with the archwire 18. On the occasion that the upper rail portions 90b, 92b do not engage with the archwire 18, the ability to control rotation may be diminished. In one aspect of the invention, the height of the upper rail portions 90b, 92b may be selected or otherwise reshaped so as to offset the tolerance stack ups in the orthodontic bracket 10 and/or archwire 18 such that one or both of the upper rail portions 90b, 92b engage the archwire 18 in the manner more fully described below.

Accordingly, as shown in FIG. 4A, when the ligating slide 14 is in the closed or ligating position, the archwire control structure 88, opposing side walls 36, 38 and base surface 34 of the archwire slot 16 form a four-sided boundary to retain the archwire 18 in the archwire slot 16. In particular, when the ligating slide 14 is in the closed position, the projecting portions 90, 92 with recessed area 94 are positioned labially of the archwire slot 16 and form the labial boundary thereof. Thus, movement of the archwire 18 may cause the archwire 18 to contact one or both of projecting portions 90, 92. Since the projecting portions 90, 92 form the labial boundary, the archwire 18 may not contact another portion of the ligating slide 14 during treatment.

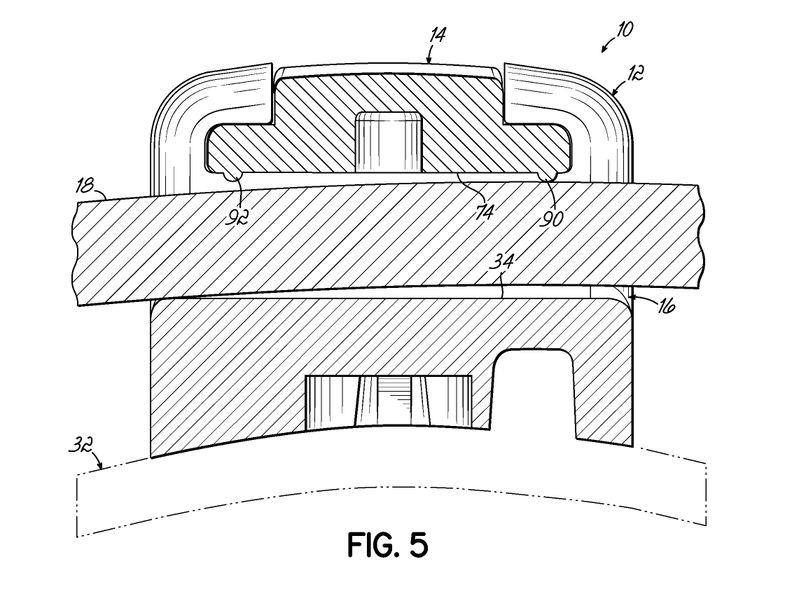

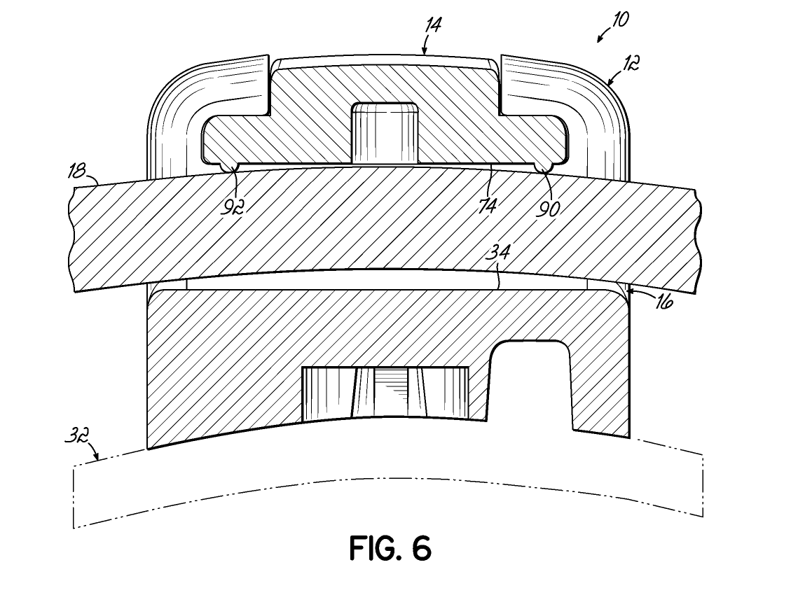

Accordingly, due to the archwire control structure 88, the rotational forces may be predetermined and controlled to a greater extent because the moment arm formed thereby may be both larger and more consistent throughout orthodontic treatment. By way of example, and as illustrated in FIG. 5, the archwire 18 may be oriented such that it contacts both the bracket body 20 and the projecting portion 90, thereby forming a moment arm defined by the distance between the contact points. As shown, with the archwire 18 in this orientation, a force generated by the archwire 18 may produce a torque, due to the moment arm, to rotate the bracket 10 (and tooth) into the desired position. In addition, since the contact points between the archwire 18 and the orthodontic bracket 10 are relatively constant, as the contact points on the ligating slide 14 (i.e., on the archwire control structure 88) remain consistent during treatment, the moment arm remains relatively consistent.

With regard to consistency of the contact points, according to embodiments of the invention, the contact points between the bracket body 20 and the ligating slide 14 may not substantially shift as treatment progresses. Accordingly, the moment arm and thus the torque applied to the tooth are more consistent. Thus, the rotational forces are more predictable. By way of example, the archwire 18 may be oriented in a non-parallel manner relative to the archwire slot 16. During treatment, where the archwire 18 bends, due to movement of the bracket 10, such that an apex (not shown) of the bend forms between the projecting portions 90, 92, and within the recessed area 94, the apex does not contact another location. That is, the archwire 18 does not contact the surface between the projecting portions 90, 92. Therefore, no forces develop between that surface and the archwire 18 that would lead to an unpredictable moment arm. Rather, the archwire 18 remains in contact with one of the projecting portions 90, 92 and the moment arm may remain substantially constant until the orthodontic bracket 10 moves to an orientation where the archwire 18 does not contact the ligating slide 14. At this point, the archwire 18 may be substantially aligned with the archwire slot 16.

While the archwire 18 contacts the projecting portion 90 and the archwire slot 16 on the base surface 34 at the distal end thereof, it will be appreciated that the orientation of the archwire 18 may be reversed. For example, the archwire 18 may have an orientation whereby contact occurs at the projecting portion 92 and at the mesial end of the base surface 34. Such a configuration will provide the benefits and advantages as described above related to a more consistent moment arm and torque, but provide rotation in a direction opposite to that described above.

In the finished state, the archwire 18 may make two points of contact on the archwire control structure 88. By way of example, the archwire 18 may make contact with each of the projecting portions 90, 92. Near the end of treatment, this configuration mimics the fine rotation control provided by traditional methods of ligation, such as ligating an archwire to a bracket with traditional ligatures, and thereby improves finishing in clinical cases. It will be appreciated that for the anterior section of lower and upper jaws, the flat occlusal edges of the incisor teeth magnify distortions in rotation such that fine control is desired and fine control may be provided according to embodiments of the present invention.

Given that the archwire-ligating slide contact points are limited to specific, predetermined locations in the embodiments shown, e.g., the projecting portions 90, 92, the clinician may be more likely to be able to assess the clinical result of a change in treatment for a given orthodontic bracket, archwire, and tooth orientation or may be able to affect a certain rotational motion more quickly. Furthermore, the moment arm formed by contact between the archwire and the archwire control structure may be maximized to rotate the bracket 10 and tooth in more efficient and optimal manner.

Various modifications may be made to the archwire control structure 88 in accordance with the description set forth above. For example, the desired contact locations between the archwire 18 and the ligating slide 14 may be adjusted to allow for a particular torque or to allow use of archwires of differing dimension. In this regard, the height of the projecting portions 90, 92 (e.g., depth of the recessed area 94) may be changed to accommodate changes in the orthodontic bracket and/or archwire dimensions. This may allow the orthodontic bracket 10 to accommodate manufacturing tolerance stack ups without sacrificing rotational control.

Additionally, to change the magnitude of the moment arm, the recessed area 94 may be extended to cover a larger portion of the lingual surface 74 of the ligating slide. It will be appreciated that moving the projecting portions 90, 92 apart in the mesial-distal direction may further improve the length of the moment arm. Maximizing the distance between the two points of contact (e.g., one on the base surface 34 of the archwire slot 16 and the other on the lingual surface 74 of the ligating slide 14), maximizes the moment arm and, consequently, maximizes the torque for a given force. Accordingly, smaller forces may be used to provide the same amount of torque. In one embodiment, the recessed area 94 extends a sufficient dimension along the lingual surface 74 such that projecting portion 90, 92 reside on the mesial-most and distal-most edges of the ligating slide 14.

While the present invention has been illustrated by a description of various embodiments and while these embodiments have been described in some detail, it is not the intention of the Applicant to restrict or in any way limit the scope of the appended claims to such detail. Additional advantages and modifications will readily appear to those of ordinary skill in the art. The various features discussed herein may be used alone or in any combination depending on the needs and preferences of the user. This has been a description of illustrative aspects and embodiments of the present invention, along with the methods of practicing the present invention as currently known. However, the invention itself should only be defined by the appended claims.

What is claimed is:

1. An orthodontic bracket comprising:
a bracket body adapted to be secured to a tooth and including an archwire slot having a base surface, a first side wall and a second side wall each extending from the base surface, the archwire slot further including an opening opposite the base surface for receiving an archwire therein, and
a closure member movable between an open position and a closed position, the bracket body configured to receive the archwire in the archwire slot when in the open position and configured to retain the archwire in the archwire slot when in the closed position; and
archwire control structure on the closure member to enhance rotational control during orthodontic treatment, wherein the closure member includes a generally planar surface that confronts the archwire slot in the closed position, and the archwire control structure comprises:
a first projecting portion adjacent a first side of the closure member and projecting above the generally planar surface; and
a second projecting portion adjacent a second side of the closure member and projecting above the generally planar surface,
wherein a recessed area is defined by the generally planar surface and first and second projecting portions which overlies the archwire slot when the closure member is in the closed position.

2. The orthodontic bracket of claim 1, wherein the first and second projecting portions include ribs projecting above the generally planar surface of the closure member.

3. The orthodontic bracket of claim 2, wherein the closure member moves between the open and closed positions along a translation axis, and wherein each of the ribs extends in a direction substantially parallel to the translation axis.

4. The orthodontic bracket of claim 1, wherein the bracket body includes a support surface extending from one of the side walls of the archwire slot and positioned on one side of the archwire slot, and wherein the support surface includes recesses that receive the first and second projecting projections when the closure member is in the opened position.

5. The orthodontic bracket of claim 4, wherein the support surface is a generally planar surface and the recesses include a pair of grooves extending below the generally planar surface.

6. The orthodontic bracket of claim 5, wherein each of the grooves is open to the archwire slot.

7. The orthodontic bracket of claim 4, wherein the closure member moves between the open and closed positions along a translation axis, and wherein each of the grooves extends in a direction substantially parallel to the translation axis.

8. The orthodontic bracket of claim 1, wherein the closure member includes a pair of spaced-apart ribs projecting above the generally planar surface of the closure member, wherein at least a portion of the ribs operates as the archwire control structure and a portion of the ribs extends beyond the archwire slot when the closure member is in the closed position.

9. The orthodontic bracket of claim 8, wherein the closure member moves between the open and closed positions along a translation axis, wherein each of the ribs extends in a direction substantially parallel to the translation axis.

10. The orthodontic bracket of claim 8, wherein each of the ribs constitutes a continuous elongate member.

11. The orthodontic bracket of claim 8, wherein each of the ribs includes an upper rib portion and a lower rib portion separated from each other, wherein the upper rib portions overlie the archwire slot when the closure member is in the closed position and operates as the archwire control structure.

12. The orthodontic bracket of claim 8, wherein the bracket body includes a support surface extending from one of the side walls of the archwire slot and positioned on one side of the archwire slot, and wherein the support surface includes recesses that receive at least a portion of the ribs when the closure member is in the opened position.

13. The orthodontic bracket of claim 12, wherein the recesses receive at least a portion of the ribs when the closure member is in the closed position.

14. The orthodontic bracket of claim 12, wherein the support surface is a generally planar surface and the recesses include a pair of grooves extending below the generally planar surface.

15. The orthodontic bracket of claim 14, wherein each of the grooves is open to the archwire slot.

16. The orthodontic bracket of claim 14, wherein the closure member moves between the open and closed positions along a translation axis, and wherein each of the grooves extends in a direction substantially parallel to the translation axis.

17. The orthodontic bracket of claim 1, wherein the closure member is a ligating slide.

18. A method of correcting malpositioned teeth, comprising:
applying a plurality of orthodontic brackets to teeth of a patient, each bracket comprising:
a bracket body adapted to be secured to a tooth and including a an archwire slot having a base surface, a first side wall and a second side wall extending from the base surface, the archwire slot further including an opening opposite the base surface for receiving an archwire therein, and
a closure member movable between an open position and a closed position, the bracket body configured to receive the archwire in the archwire slot when in the open position and configured to retain the archwire in the archwire slot when in the closed position; and
archwire control structure on the closure member to enhance rotational control during orthodontic treatment, wherein the closure member includes a generally planar surface that confronts the archwire slot in the closed position, and the archwire control structure comprises:
a first projecting portion adjacent a first side of the closure member and projecting above the generally planar surface; and
a second projecting portion adjacent a second side of the closure member and projecting above the generally planar surface,
wherein a recessed area is defined by the generally planar surface and first and second projecting portions which overlies the archwire slot when the closure member is in the closed position; and
retaining an archwire in the respective archwire slots of the orthodontic brackets such that the archwire contacts at least one of the first or second projecting portions and without contacting another portion of the ligating member.

19. The method of claim 18, further comprising altering a height of at least one of the projecting portions above the generally planar surface to affect rotational control on a tooth.
